(19) United States
(12) Patent Application Publication
(10) Pub. No.: US 2017/0051081 A1
(43) Pub. Date: Feb. 23, 2017

(54) APPARATUS FOR HALOGENATION OF POLYMER

(71) Applicant: Reliance Industries Limited, Mumbai (IN)

(72) Inventors: Pradip Munshi, Vadodara (IN); Ninad Ingle, Pune (IN); Pradeep Paresh Kapadia, Mumbai (IN); Raksh Vir Jasra, Vadodara (IN)

(73) Assignee: Reliance Industries Limited, Mumbai (IN)

(21) Appl. No.: 15/308,568

(22) PCT Filed: Apr. 24, 2015
(86) PCT No.: PCT/IB2015/052999

§ 371 Date: Nov. 2, 2016

(30) Foreign Application Priority Data
May 2, 2014 (IN) 1536/MUM/2014

(51) Int. Cl. C08F 8/22; B01J 19/00; B01J 19/02; B01J 19/06; B01J 19/12

(52) U.S. Cl. CPC C08F 8/22; B01J 19/06; B01J 19/123; B01J 19/02; B01J 19/0066; B01J 2219/0254; B01J 2219/0877; B01J 2219/1203

(57) ABSTRACT

An apparatus for halogenation of a polymer is disclosed. The apparatus includes a reactor, at least one light source, a stirrer and a heater. The reactor contains a slurry of the polymer. The light source is disposed outside of the reactor at a distance ranging from 0.5 centimeter to 2 centimeters for facilitating irradiance of the slurry. The light source radiates a light of wavelength in the range of 250 nm to 355 nm. The stirrer is adapted to agitate the slurry. The heater is adapted to heat the slurry of the polymer. The blades on the stirrer and light source are arranged in such a way that slurry is maintained in uniform motion and reacted homogeneously to achieve desired conversion efficiently.

### FIELD OF THE DISCLOSURE

The present disclosure relates to an apparatus for halogenation of a polymer.

### BACKGROUND

Polyvinyl chloride (PVC) is converted to chlorinated polyvinyl chloride (CPVC) by chlorination via a free radical reaction which is initiated by application of heat and/or UV light. Chlorine content of the polymer defines its properties and applications. Most commercial CPVC resins have chlorine content in the range from 63% to 69%. The time required for desired chlorine content, extent of chlorination, colour and uniformity of chlorination at a particular temperature are important parameters for efficient preparation of high quality product.

However, conventional apparatus for halogenation of polymers have not been effective in performing efficient halogenation. Such apparatus are ineffective in obtaining a high halogenation reaction rate. Further, halogenated polymers formed by using such apparatus are non-uniform in nature which results in poor physical properties of the polymers. Furthermore, conventional apparatus cause a non-uniform distribution of temperature in the polymer bed of the vessel which results in localized hot spots. These hot spots in turn cause solid polymer masses to build-up in the static areas of the reactor (such as on the reactor head), thereby causing a layer of polymer on the upper surface of the slurry which restricts radiations used in the halogenation process to penetrate the entire slurry. Due to build-up of polymer masses in the static areas, the polymer tends to bridge and plug the discharge lines. This may in turn increase the level of the polymer bed in the vessel and eventually leads to a complete shutdown of the reactor.

Some of the Prior Art is Described Below:

U.S. Pat. No. 3,591,571 mentions a process that is carried out with the help of a device having a cylindrical glass autoclave equipped with a circulating water jacket, a thermometer, a paddle type agitator and a plurality of UV lamps surrounding the reactor. The water jacket is provided with circulating warm water.

U.S. Pat. No. 4,377,459 mentions chlorination process that is carried out with the help of a device having a reactor with a jacket, a paddle stirrer having a central shaft and blades provided to churn a mass of macrogranules of PVC in the reactor and a bank of ultraviolet lamps sealingly fitted into the cover of the reactor.

U.S. Pat. No. 4,102,760 mentions a process for post chlorinating vinyldene fluoride polymer to provide a chlorinated resin. Chlorination of vinyldene fluoride polymer is performed with the help of a device having a cylindrical glass reactor equipped with a quartz immersion water-cooled condenser containing a quartz mercury vapor lamp (an ultraviolet light source) and a stirrer.

U.S. Pat. No. 6,384,149 mentions a method of preparation of a polyvinyl chloride resin having an average particle diameter of at least 150 μm and porosity of at least 0.15 cc/g at 31-1011 psi. The chlorination process is performed by suspending the resin in an aqueous medium and chlorinated by blowing gaseous chlorine into aqueous suspension. The method is carried out by using a device having a reactor equipped with a stirrer.

Chlorination of vinyl chloride resin is performed by using an apparatus having a glass tank equipped with a stirrer and a mercury lamp (UV lamp).

U.S. Pat. No. 4,377,459 mentions a process for the preparation of CPVC in the form of free-flowing macro-granules of PVC. The chlorination process is carried out with the help of a device having a reactor with a jacket, a paddle stirrer having a central shaft and blades provided to churn a mass of macrogranules of PVC in the reactor and a bank of ultraviolet lamps sealingly fitted into the cover of the reactor.

GB1318078 mentions a process for chlorination of granular PVC or polyethelene with gaseous chlorine at a pressure from 1 to 5 atm absolute in the presence of a radical forming agent and/or under the influence of a radiation wherein the finely granular polymer is chlorinated in a mechanically produced fluidized layer. The process is carried out by using a reactor having plough shaped agitating members arranged about a central horizontal axis of a mixer.

U.S. Pat. No. 6,197,895 mentions a process for the production of chlorinated polyvinyl chloride resin. In producing CPVC resin having chlorine content from 60 to 73% by weight wherein PVC resin is suspended in aqueous medium and chlorine gas is blown into said suspension under beam of a mercury lamp in the temperature range of a 40° C. to 90° C. An organic peroxide compound having a 10 h half-life in the range of 40 to 90° C. is added into reaction vessel in the ratio of 0.01 -1 parts to 100 part of the PVC resin by weight before the chlorination reaction is started.

However, an apparatus that performs uniform chlorination of the polymer has not been mentioned. Further, in the suggested processes a layer is formed on the upper surface of the slurry within a reaction vessel which reduces stability due to an increase in polymer residue. Furthermore, facilitation of a uniform reaction and increased rate of chlorination has not been mentioned.

There is thus felt a need for an apparatus for halogenation of a polymer, having the aforesaid parameters.

### OBJECTS

Some of the objects of the present disclosure aimed to reduce one or more problems or to at least provide an alternative method, are listed herein below:

An object of the present disclosure is to provide an apparatus that provides a homogeneous mass within a reactor.

Another object of the present disclosure is to provide an apparatus that accelerates reaction rate in a polymerization process.

Another object of the present disclosure is to provide an apparatus that uniformly distributes temperature within a reactor.

Another object of the present disclosure is to provide an apparatus that eliminates formation of hot spots in a reactor.

Still another object of the present disclosure is to provide an apparatus that facilitates a uniform and increased rate of reaction.

Further object of the present disclosure is to provide an apparatus that eliminates formation of layer on the upper surface of slurry within a reactor.

Further object of the present disclosure to provide an apparatus that is simple in construction.

Further object of the present disclosure is to provide an apparatus that prepares a polymer in a short period of time.

Further object of the present disclosure is to provide an apparatus that consumes comparatively less amount of energy.

Still another object of the present disclosure is to provide an apparatus that eliminates treatment of the slurry before polymerization process.

Other objects and advantages of the present disclosure will be apparent from the following description when read in conjunction with the accompanying figures, which are not intended to limit the scope of the present disclosure.

### SUMMARY

In accordance with an embodiment of the present disclosure, there is provided an apparatus for the halogenation of a polymer. The apparatus includes a reactor, at least one light source, a stirrer and a heater. The reactor receives slurry for the halogenation of the polymer. The light source is disposed outside of the reactor at a distance ranging from 0.5 centimeters to 2 centimeter for facilitating irradiation into the slurry. The stirrer is adapted to agitate the slurry of the polymer. The heater is adapted to heat the slurry of the polymer.

In accordance with an embodiment of the present disclosure, the apparatus further includes a temperature sensing element for sensing temperature of the slurry.

Preferably, at least one light source is disposed at a distance of 0.2 to 10 cm more particularly from 0.5 to 2 cm from the reactor.

Typically, the at least one light source is a ultra-violet light source.

Preferably, the at least one light source radiates a light of wavelength in the range of 250nm to 355nm.

Typically, the stirrer has a plurality of blades.

In accordance with an embodiment of the present disclosure, each of the blades has a blade angle of 30-60 degrees, preferably 45 degrees.

Preferably, the heater heats the slurry at a temperature of 60-100° C., preferably 70° C.

Typically, the reactor is a quartz reactor.

Preferably, the apparatus is adapted to effect at least 67% halogenation (by weight) of the polymer over a time period ranging between 5 hours and 12 hours.

### BRIEF DESCRIPTION OF THE ACCOMPANYING DRAWINGS

The apparatus for halogenation of a polymer of the present disclosure will now be described with the help of the accompanying drawings, in which:

FIG. 1 illustrates a schematic representation of an apparatus for halogenation of a polymer in accordance with an embodiment of the present disclosure;

FIG. 2 illustrates a perspective view of a stirrer of the apparatus of FIG. 1;

FIG. 3 illustrates a perspective view of a plurality of blades of a stirrer in accordance with an embodiment of the present disclosure;

FIG. 4 illustrates a graphical representation of relation between distance of the light source from reactor surface and Time (h) to reach 67% chlorination (by weight) and Thermal Stability by conductivity (sec)×100; and

FIG. 5 illustrates a graphical representation of relation between angle of the stirrer and time required to reach 67% chlorination (by weight) and Thermal Stability by conductivity (sec)×100.

### DETAILED DESCRIPTION

The apparatus for halogenation of a polymer of the present disclosure will now be described with reference to the embodiments which do not limit the scope and ambit of the disclosure. The description relates purely to the exemplary preferred embodiments of the disclosed apparatus and its suggested applications.

The apparatus herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

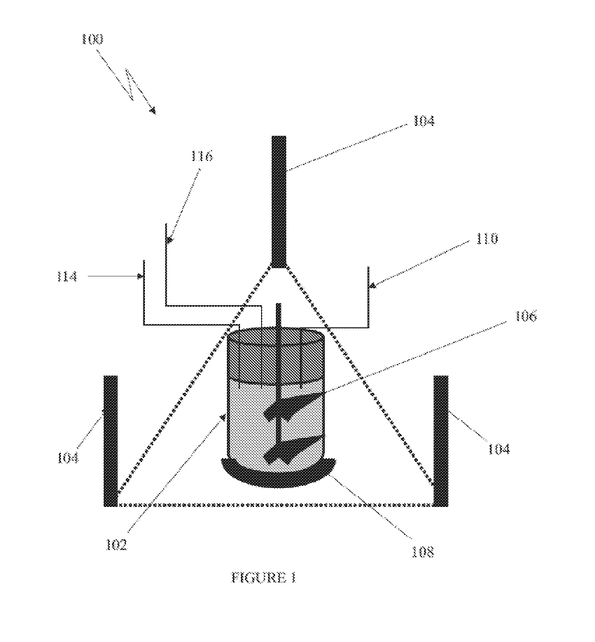

Referring to FIG. 1, the apparatus 100 for halogenation of a polymer in accordance with an embodiment of the present disclosure includes the following components:
a reactor 102;
at least one light source 104;
a stirrer 106; and
a heater 108.

The reactor 102 is adapted to contain slurry for halogenation of the polymer. Typically, the walls of said reactor 102 are made of glass and preferably quartz. In one embodiment, the reactor 102 is adapted to accommodate the polyvinyl chloride (PVC) slurry. The reactor 102 is surrounded by at least one light source 104 for facilitating irradiation of slurry and to increase the rate of reaction for halogenation of the polymer. Typically, the light source 104 is provided such as to cover maximum surface area of the reactor 102 for increasing the efficiency of the halogenation process of the polymer and reducing hot spot within the reactor 102. In one embodiment, the light source 104 is disposed outside of the reactor 102 at a distance ranging from 0.5 cm to 2 cm as illustrated in FIG. 1. Preferably, the light source 104 is disposed outside the reactor 102 at a distance of 1 centimeter from the reactor 102. In another embodiment, the apparatus 100 includes three light sources 104. Generally, the slurry has varying refractive index throughout the depth of the reactor 102. Due to which transmittance of light through the slurry decayed to ⅕^{th} in 1 cm from the surface of the reactor wall indicating reasonable irradiance of the slurry during reaction. The light source 104 includes but is not limited to an ultraviolet light source. In accordance with an embodiment of the present disclosure, the light source 104 radiates light of wavelength in the range of 250 nm to 355 nm. The light source 104 is chosen from the group consisting of solid state light source, gas discharge light source, organic light source, LASER and high-intensity discharge light source. Typically, the proportion of irradiation flux exposed to the surface of the reactor 102 is in the range of 10-50 mWatts/cm² and preferably in the range of 15-25 mWatts/cm².

Referring to FIG. 2, the stirrer 106 has a plurality of blades 118 having a predefined blade angle. In one embodiment, the blade angle is approximately 45 degrees. The plurality of blades 118 are attached to a spindle 120. In accordance with the present disclosure, number of blades 118 of the stirrer 106 is ranging from 2 to 10. In accordance with an embodiment of the present disclosure, the blades 118 are integral with the spindle 120. In accordance with another embodiment of the present disclosure, the blades 118 are removably fixed to the spindle 120. The stirrer 106 is disposed inside the reactor 102 for agitating the mass of the slurry while halogenation of the polymer to get a homogeneous mass of the slurry inside the reactor 102. The stirrer 106 prevents formation of layer on an upper surface of the slurry within the reactor 102, thereby preventing floating of the layer of slurry on the upper surface of the slurry within the reactor 102. Tilting of the blades 118 at a blade angle of about 45 degrees facilitates optimized flow pattern of the slurry to avoid floating of the layer of slurry on the upper surface of the slurry within the reactor 102. Floating of the layer of slurry on the upper surface of the slurry within the reactor 102 depends upon the stirring speed and the construction of the stirrer 106. Generally, floating of the layer of slurry on the upper surface of the slurry within the reactor 102 reduces with increase in the stirring speed. In accordance with an embodiment of the present disclosure, the speed of the stirrer 106 is optimized in the range of 400 rpm to 800 rpm such that the tip of vortex formed by stirring process remains above the blades 118. The stirrer 106 also eliminates choosing of exact particle size range of the polymer and addition of dispersion or swelling agents.

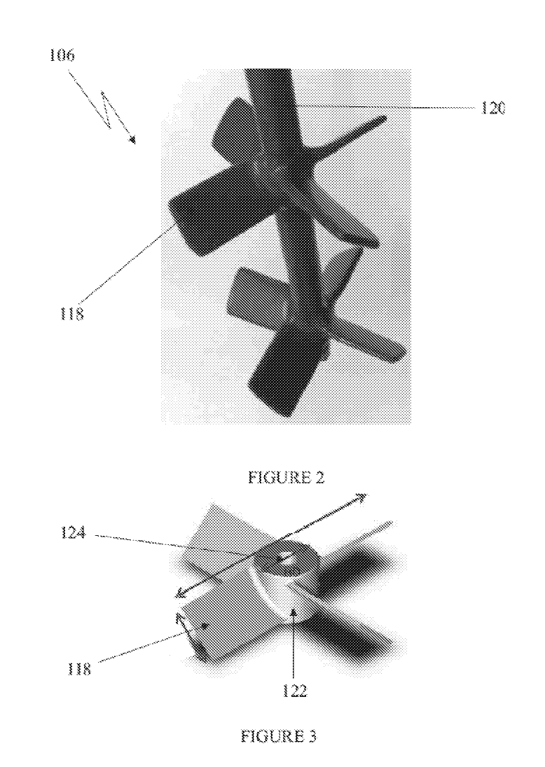

Referring to FIG. 3, the stirrer 106 includes at least one impeller 122 in accordance with an embodiment of the present disclosure. Each of the impeller 122 has a central opening 124. In one embodiment, the impeller 122 is a pedal type impeller. However, the present disclosure is not limited to any particular type of impeller described. The spindle 120 is coaxially inserted through the central opening 124. Further, the blades 118 are radially extended from the impeller 122. In accordance with an embodiment of the present disclosure, the blades 118 are integral with the impeller 122. In accordance with another embodiment of the present disclosure, the blades 118 are removably fixed to the impeller 122. The blades 118 are spaced apart from each other with a distance depending upon the number of blades 118.

Further, coloration of halogenated polymer appears due to higher temperature. The heater 108 is provided to heat the slurry at a temperature of around 70° C. which prevents coloration of the polymer. The heater 108 is provided to uniformly distribute the temperature within the reactor 102. In accordance with an embodiment of the present disclosure, apparatus 100 includes a temperature sensing element 110 for sensing temperature of the slurry inside the reactor 102. The temperature sensing element 110 co-operates with the heater 108 to maintain the temperature of the slurry at around 70° C.

In accordance with an exemplary embodiment of the present disclosure, the stirrer 106 is installed in a vessel such as a reactor 102 used for chlorination of polyvinyl chloride (PVC) of K value 67 to obtain chlorinated polyvinyl chloride (CPVC) of 67% chlorine (by weight). Generally, a quartz reactor is used as the vessel. The vessel is filled with 18% (by weight) aqueous PVC slurry and is surrounded by light sources 104 such as ultra-violet (UV) lamps radiating a light of wavelength about 254 nm. The PVC slurry is chlorinated at about 70° C. under chlorine (gas) flow of about 29.7 g/h and nitrogen gas flow through a dual inlet 114 and a dual outlet 116. The entire process of producing CPVC is optimized using the energy emitted from the light source 104. It is generally observed that the a layer of CPVC slurry floats on the top surface of the slurry which results in an opaque slurry that restricts the UV light to penetrate the slurry for uniform chlorination of the PVC. The stirrer 106 in accordance with the present disclosure eliminates formation of layer of CPVC slurry on the top surface of the slurry and increases the chlorination rate. The stirrer 106 is operated with a predefined speed by using a rotator, during the process of chlorination. Typically, the distance between the blades 118 is kept in the range of 2 to 6 inches. Floating of the CPVC reduces with the increase in speed of the stirrer 106. A typical range for the speed of rotation of the stirrer 106 in accordance with this embodiment is in the range of 400 rpm to 800 rpm.

The present disclosure is further described in light of the following examples which are set forth for illustration purpose only and not to be construed for limiting the scope of the disclosure.

### EXAMPLE 1

1010 g aqueous PVC slurry from plant containing 160 g PVC was taken in a reactor 102. Agitation was started at speed of 200 rpm for initial 5 min while nitrogen gas was purged inside the reactor 102 through the slurry. Speed of rotation of stirrer 106 was increased to 650 rpm and nitrogen purging was continued for another 40 min in order to remove air or oxygen from the reactor 102 and slurry. Nitrogen flow was stopped and chlorine was purged through the slurry maintaining same conditions. Ultraviolet (UV) lamp was switched on when the reactor 102 and slurry were found to be saturated with chlorine. Temperature was maintained at 70° C. similar to the plant slurry temperature. After 6 h of UV lamp irradiation, reaction was stopped and chlorine purging was replaced by nitrogen purging for 1 hour. The chlorinated polyvinyl chloride (CPVC) slurry thereafter was filtered and washed with 1500 mL water in three parts. The wet cake was dried at 70° C. under blow of air and CPVC was obtained as white dry powder. Percentage of chlorine content (by weight) was checked by weight increase in respect to PVC dry powder using formula:

Percentage of Chlorine in CPVC=[102.9−46.2(A/B)];

wherein A=weight of PVC in gram,

B=weight of CPVC obtained in gram.

The chorine present in A gram PVC was considered 0.567 A gram. The result was validated by ASTM F 442M-99, oxygen flask method which remained within ±0.5%.

### EXAMPLE 2

In this example the reaction and recovery of CPVC were carried in similar manner as in example 1 except the time for UV irradiation was 4 hours.

### EXAMPLE 3

In this example the same reaction in similar manner was carried as in example 1 except the time for UV irradiation was 2 hours.

### EXAMPLE 4

The procedure for this example remains unchanged as that of example 1 except that the reaction temperature was maintained at 90° C. throughout the reaction.

### EXAMPLE 5

Everything remains unchanged to this example except the UV lamps of only 354 nm wavelength were used than those mentioned in example 1.

### EXAMPLE 6

This example illustrates the speed of rotation of agitator kept at 400 rpm while keeping the process unchanged to that used in example 1.

### EXAMPLE 7

This example states the speed of rotation 900 rpm while the process is unchanged to that used in example 1. The material was found to be splashed on top of the reactor resulting in ineffective chlorination.

### EXAMPLE 8

This example illustrates the reaction in similar way that was carried out in example 1 except the time of reaction was prolonged to 9 hours.

### EXAMPLE 9

Similar reaction was carried as described in example 1. Only difference made was washing at end of the reaction. Mother liquor of the reaction was neutralized by sodium hydroxide, filtered and washed with 1000 mL water to get rid of sodium chloride and excess sodium hydroxide.

### EXAMPLE 10

This example states that the same amount of plant slurry as used in example 1 was filtered using Whatman-42 filter paper where no visible particle and sediment was seen on the filtrate. The filtrate was chlorinated at similar condition to that stated in example 1. No solid was formed and thus could not be collected; interpreting that slurry liquid did not generate any solid material that added to the weight in CPVC resin.

TABLE 1 is provided herein below which summarizes the above examples:

| | | Wave- | | | | | |
|---|---|---|---|---|---|---|---|
| | | length | | | Speed | | |
| | | of UV | | | of | Wash- | % Cl |
| | PVC | rays | Temp | Time | stirrer | ing | (by |
| Example | slurry/g | (nm) | (° C.) | (h) | (rpm) | agent | weight) |
| 1 | 1081 | 254 | 70 | 6 | 650 | Water | 67.37 |
| 2 | 1081 | 254 | 70 | 4 | 650 | Water | 65.96 |
| 3 | 1081 | 254 | 70 | 2 | 650 | Water | 64.06 |
| 4 | 1081 | 254 | 90 | 6 | 650 | Water | 66.2 |
| 5 | 1081 | 350 | 70 | 6 | 650 | Water | 66.3 |
| 6 | 1081 | 254 | 70 | 6 | 400 | Water | 66.00 |
| 7 | 1081 | 254 | 70 | 6 | 900 | Water | 66.02 |
| 8 | 1081 | 254 | 70 | 9 | 650 | Water | 69.22 |
| 9 | 1081 | 254 | 70 | 6 | 650 | NaOH | 66.65 |
| 10 | Slurry | 254 | 70 | 6 | 650 | Water | 0 |
| | Liquid | | | | | | |
| | 850 mL | | | | | | |

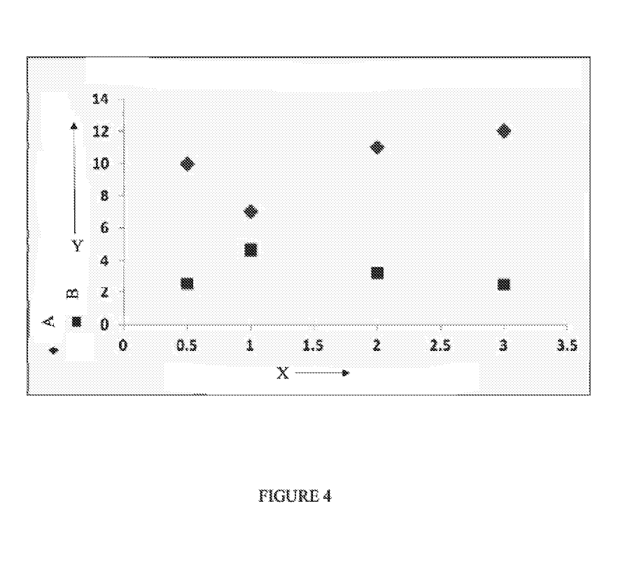

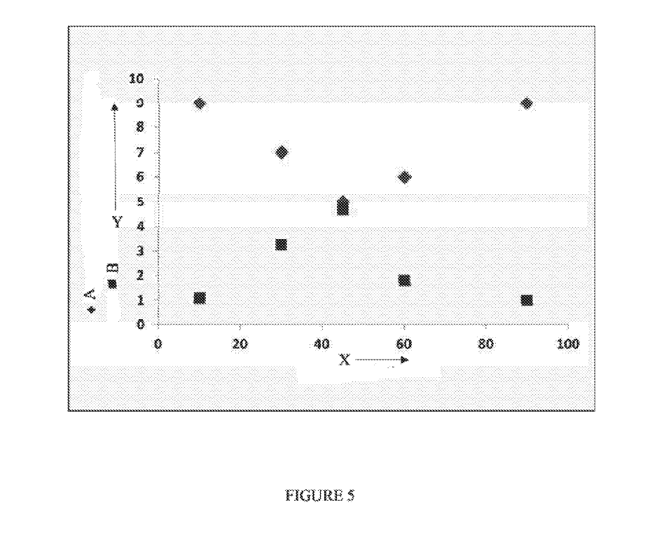

TABLE 2 shows relation between distance of light source from reactor surface, Time (h) to reach 67% chlorination (by weight) and Thermal Stability by conductivity (sec)×100. FIG. 4 illustrates a graphical relation between distance of light source from reactor surface, Time (h) to reach 67% chlorination (by weight) and Thermal Stability by conductivity (sec)×100, where distance of light source from reactor surface is represented by “X” axis, time (h) to reach 67% chlorination (by weight) is represented by “A” and thermal stability by conductivity (sec)×100 is represented by “B”. Both “A” and “B” are represented by the “Y” axis.

TABLE 2

| Distance of light source | Time (h) to reach | Thermal Stability |
|---|---|---|
| from reactor surface | 67% chlorination | by conductivity |
| (cm) | (by weight) | (sec) × 100 |
| 0.5 | 10 | 2.52 |
| 1 | 7 | 4.68 |
| 2 | 11 | 3.24 |
| 3 | 12 | 2.5 |

In light of the TABLE 2, time to reach 67% chlorination (by weight) is minimal when the light source is disposed at a distance of 1 cm from the reactor surface. Further, thermal stability by conductivity is maximum when the light source is disposed at a distance of 1 cm from the reactor surface.

TABLE 3 shows a relationship between blade angle, time taken to reach 67% chlorination (by weight) of PVC and thermal stability by conductivity (sec)×100. FIG. 4 illustrates a graphical relation between blade angle, time taken to reach 67% chlorination (by weight) of PVC and thermal stability by conductivity (sec)×100, where blade angle in degrees is represented by “X” axis, time taken to reach 67% chlorination (by weight) of PVC is represented by “A” and thermal stability by conductivity (sec)×100 is represented by “B”. Both “A” and “B” are represented by the “Y” axis.

TABLE 3

| | Time (h) to reach | Thermal stability |
|---|---|---|
| Blade angle | 67% chlorination | by conductivity |
| (degree) of stirrer | (by weight) | (sec) × 100 |
| 10 | 9 | 1.08 |
| 30 | 7 | 3.24 |
| 45 | 5 | 4.68 |
| 60 | 6 | 1.8 |
| 90 | 9 | 1 |

In light of TABLE 3, time to reach 67% chlorination (by weight) is minimal at a blade angle of 45 degrees. Further, thermal stability by conductivity is maximum at a blade angle of 45 degrees.

### TECHNICAL ADVANCEMENTS AND ECONOMIC SIGNIFICANCE

The technical advantages of the apparatus envisaged by the present disclosure include the realization of:
an apparatus that provides a homogeneous mass of the fluid;
an apparatus that increases reaction rate in halogenation process;
an apparatus that facilitates a uniform and increased the rate of reaction;
an apparatus that uniformly distributes the temperature within a reaction vessel;
an apparatus that eliminates formation of hot spots in the reaction vessel;
an apparatus that eliminates formation of layer on the upper surface of the slurry within the reaction vessel;
an apparatus that is simple in construction;
an apparatus that halogenates a polymer in a short period of time;
an apparatus that consumes lower energy; and
an apparatus that eliminates treatment of the slurry before halogenation process.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. An apparatus for halogenation of a polymer, said apparatus comprising:
a reactor for receiving polymer slurry for halogenation of said polymer;
at least one light source disposed outside of said reactor at a distance ranging from 0.5 centimetre to 2 centimetres for facilitating irradiation into said slurry; and
a stirrer adapted to agitate said slurry.

2. The apparatus as claimed in claim 1, wherein the walls of said reactor are made of quartz.

3. The apparatus as claimed in claim 1, wherein at least one light source is disposed at a distance of 1 centimetre from said reactor.

4. The apparatus as claimed in claim 1, wherein at least one light source is a ultra-violet light source.

5. The apparatus as claimed in claim 4, wherein at least one light source radiates alight of wavelength in the range of 250 nm to 355 nm.

6. The apparatus as claimed in claim 1, wherein said stirrer has a plurality of blades.

7. The apparatus as claimed in claim 6, wherein each of said blades has a blade angle of 30-60 degrees, preferably 45 degrees.

8. The apparatus as claimed in claim 1 further comprising a heater adapted to heat the slurry of polymer with at least one temperature sensing element for sensing the temperature of said slurry.

9. A process for halogenating a polymer using apparatus claimed in claim 1, said process comprising of reacting stirred aqueous PVC slurry with chlorine gas to effect at least 67% halogenation (by weight) of said polymer over a time period ranging between 5 hours and 12 hours.

10. The process claimed in claim 9, wherein reaction is carried out at a temperature in the range from 60-100° C., preferably 70° C.
